(19) United States
(12) Patent Application Publication
(10) Pub. No.: US 2009/0228483 A1
(43) Pub. Date: Sep. 10, 2009

(54) AUTOMATED CONVERSION OF USER ACTIONS TO NATURAL-LANGUAGE TEXT

(75) Inventor: Michelle A. Debeus, Rodondo Beach, CA (US)

Correspondence Address: Gibb Intellectual Property Law Firm, LLC, 2568-A Riva Road Suite 304, Annapolis, MD, 21401, US

(73) Assignee: XEROX CORPORATION, Norwalk, CT (US)

(21) Appl. No.: 12/044,482

(22) Filed: Mar. 7, 2008

(51) Int. Cl. G06F 7/06

(52) U.S. Cl. 707/6; 707/E17.014

(57) ABSTRACT

A method and system automatically create a textual document of an animated tutorial. First, user interactions are recorded with a computerized device to create the animated tutorial. Then, embodiments automatically identify matching natural language terms and phrases (maintained within a file or database) corresponding to the user interactions that appear in said animated tutorial. After the user interactions are matched to terms and/or phrases, the embodiments automatically combine the matching natural language terms and phrases into a textual guide and output the textual guide to accompany the animated tutorial. Such a textual guide comprises a grammatically proper, written description of the user interactions with the computerized device.

### BACKGROUND AND SUMMARY

Embodiments herein generally relate to automatically created scripts or tutorials and more particularly to a method and system that automatically creates textual guides to accompany such tutorials.

Creating training materials and tutorials can be time consuming and tedious. Currently these materials are either created by hand or with tools that record a user's steps. Conventional automated tutorial systems only capture what occurs on the graphic user interface screen. Such conventional processes require that the user type in any desired textual information for the materials being created.

Script creation and maintenance systems are known conventionally. For example, the following tools capture screenshots and mouse movements to create flash or animated Gif tutorials/demos: TurboDemo® which is available from Balesio GmbH & Co. KG, Reutlingen, Germany; and SmartDemo available from Exalt Integral Solutions Pvt Ltd., Trivandrum, Kerala, India. Also see U.S. Patent Publication 2005/0144595, the complete disclosure of which is incorporated herein.

When operating script software programs, users demonstrate on their computer how to perform a given task (teach); and the script software program automatically creates a script that can display the demonstration of this task in the future (e.g., to a future “student” who needs to learn how to perform the task). Thus, script based systems are used for recording, automating, and sharing processes performed, for example, in a graphically driven software application. These script programs allow users to make a recording as the user performs a procedure, play the recording back automatically in the future, and share the recording with other users. Thus, a script is a set of steps (e.g., a previously recorded demonstration, etc.) that are executable by a computerized device that will output a useful, concrete, and tangible result comprising a reproduction of the demonstration that was previously saved by the “teaching” user.

Further, scripts can be saved to a wiki where they can be shared with other users, enabling people to collectively define the “best practices” for accomplishing tasks. A wiki is software that allows users to create, edit, and link web pages easily. Wikis are often used to create collaborative websites and to power community websites. However, users of animated tutorial tools must manually add text to explain the tutorials/demos, which is cumbersome and time consuming.

Therefore, embodiments herein provide a method of automatically creating a textual document of the animated tutorial. First, user interactions are recorded with a computerized device to create the animated tutorial. Then, the embodiments herein automatically identify matching natural language terms and phrases (maintained within a file or database) corresponding to the user interactions that appear in the animated tutorial. After the user interactions are matched to terms and/or phrases, the embodiments herein automatically combine the matching natural language terms and phrases into a textual guide and output the textual guide to accompany the animated tutorial. Such a textual guide comprises a grammatically proper, written description of the user interactions with the computerized device, that is useful, concrete, and tangible result.

When recording the user interactions, the embodiments herein automatically record the pattern of user inputs through a graphic user interface of a computerized device; and an operation of a graphically driven program operating on the computerized device that result from the pattern of user inputs.

Part of the inventive process can create a database by supplying the natural language terms and phrases to the database. Further, to create such a database relationships and correlations between the natural language terms and phrases and the user interactions can be established to allow the user's actions to be matched with words and/or phrases.

With such a database in place, the combining of the matching natural language terms and phrases into readable text is performed by automatically adding the natural language term and/or natural language phrase to a text file for each of the user interactions in the order in which the user performed the user interactions. This produces a string (run on sentence) of terms and phrases that can be automatically edited to create grammatically correct phrases, sentences, and paragraphs to form the textual guide. Alternatively, the steps can be listed in a numerical list, in a bullet list, etc. The lists, sentences, paragraphs, chapters, etc. can be divided according to pre-defined logic rules (topical, grammatical, etc.) or can be divided according to user action. Thus, for example, a new list, paragraph, or chapter could be begun each time the user took an action that made a new screen shot appear on the graphically driven program (as opposed to a change in an existing screen view).

The embodiments herein also include a system that includes a computerized device (having at least a processor, memory and graphic user interface); a recorder (operatively connected to or integral with the computerized device) that records user interactions with the computerized device; and a comparator (operatively connected to the recorder or integral with the computerized device) that automatically identifies matching natural language terms and phrases corresponding to the user interactions. A word processor module (that is operatively connected to the comparator or integral with the computerized device) automatically combines the matching natural language terms and phrases into a textual guide. An interface (input output device operatively connected to the word processor module or integral with the computerized device) outputs the textual guide.

Consistent with the previous embodiments, the recorder automatically records the pattern of user inputs through the graphic user interface of the computerized device and records the operation of the graphically driven program operating on the computerized device that result from the pattern of user inputs. Further, the system includes the previously described database that comprises the natural language terms and phrases, and a database file identifying relationships between the natural language terms and phrases and the user interactions.

The word processor module automatically adds the natural language term and/or the natural language phrase to a text file for each of the user interactions in an order in which the user performs the user interactions. Further, the word processor module automatically edits the text file to create grammatically correct phrases, sentences, and paragraphs to create the textual guide, as described above.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating embodiments herein;

FIG. 2 is a schematic diagram illustrating one system embodiments herein;

FIG. 3 is a schematic diagram illustrating a textual file;

FIG. 4 is a schematic diagram illustrating a textual file; and

FIG. 5 is a schematic diagram illustrating a textual file.

### DETAILED DESCRIPTION

As mentioned above, users of animated tutorial tools must manually add text to explain the tutorials/demos, which is cumbersome and time consuming. Therefore, embodiments herein record operations performed by the user. From this recording, the embodiments herein generate natural-language text that is written to a file. The natural-language text describes the actions and settings necessary to complete the operation.

The invention is an automated way to create and add textual information required for training materials, tutorials, and help files. As detailed below, the embodiments herein record a user's actions and settings and then output this information as natural-language text in a variety of file formats. The text could then be integrated by system administrators and/or technical and help writers to create training materials, tutorials, and help files. Therefore, embodiments herein provide a method of automatically creating a textual document of the animated tutorial that can be added to the animated tutorial or accompany the tutorial.

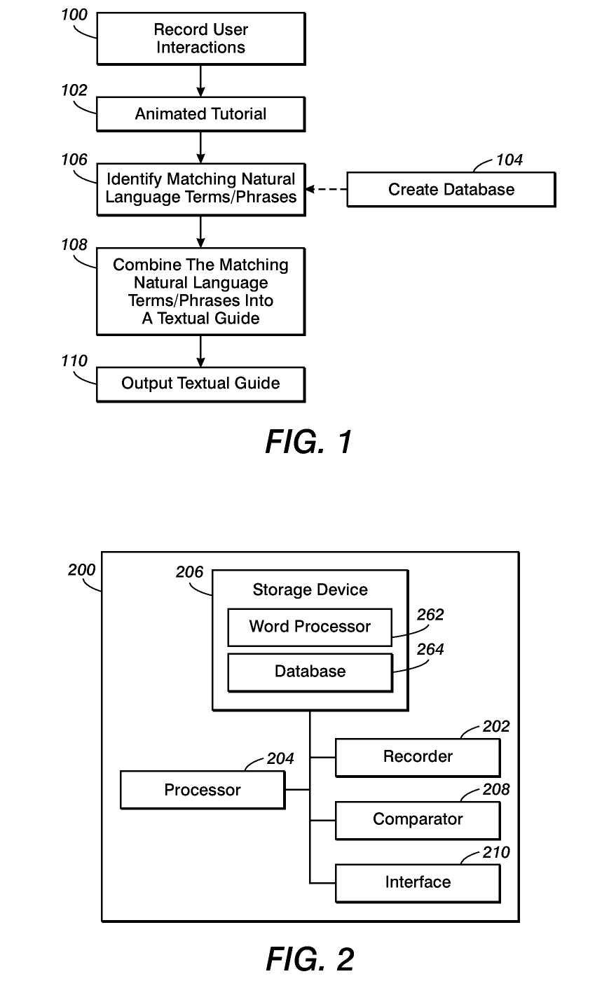

As shown in flowchart form in FIG. 1, with embodiments herein, user interactions are recorded (item 100) with a computerized device to create the animated tutorial 102. When recording the user interactions, the embodiments herein automatically record the pattern of user inputs through a graphic user interface of a computerized device; and an operation of a graphically driven program operating on the computerized device that result from the pattern of user inputs.

Then in item 106, the embodiments herein automatically identify matching natural language terms and phrases (maintained within a file or database) corresponding to the user interactions that appear in the animated tutorial. Part of this process can create a database (item 104) by manually supplying the natural language terms and phrases to any conventional database system. Further, to create such a database, relationships and correlations between the natural language terms and phrases and the user interactions can be manually established to allow the user's actions to be matched with words and/or phrases.

After the user interactions are matched to terms and/or phrases (106), the embodiments herein automatically combine the matching natural language terms and phrases into a textual guide (item 108) and output the textual guide to accompany the animated tutorial in item 110. Such a textual guide comprises a grammatically proper, written description of the user interactions with the computerized device.

With a database 104 in place, the combining of the matching natural language terms and phrases into readable text (108) is performed by automatically adding the natural language term and/or natural language phrase to a text file for each of the user interactions in the order in which the user performed the user interactions.

The embodiments herein also include a system, shown in FIG. 2, that includes a computerized device 200 (having at least a processor 204, memory 206 and interface 210 (e.g., input/output, graphic user interface, network connection, etc.). The computerized device 200 can comprise any form of automated device, including a portable or stationary computer, a personal digital assistant (PDA), a cell phone, etc.

A recorder 202 (operatively connected to or integral with the computerized device 200) records user interactions with the computerized device 200 and a comparator 208 (operatively connected to the recorder 202 or integral with the computerized device 200) automatically identifies matching natural language terms and phrases corresponding to the user interactions. A word processor module 262 (that can be maintained within the storage device 206 and which can be operatively connected to the comparator 208 or integral with the computerized device 200) automatically combines the matching natural language terms and phrases into a textual guide. The interface 210 (input output device operatively connected to the word processor module or integral with the computerized device 200) outputs the textual guide.

Consistent with the previous embodiments, the recorder 202 automatically records the pattern of user inputs through the graphic user interface 210 of the computerized device 200 and records the actions of the graphically driven program operating on the computerized device that result from the pattern of user inputs. The operating systems of most computerized devices contains commands that convert inputs from graphic user interfaces into logical commands that the software applications recognize. Additionally, application developers can programmatically add code to record operations performed by the user. The recorder 202 utilizes such information from the operating system of a computerized device 200 to interpret how the user is operating the various graphic user interface inputs, and how the software application is responding graphically to the user.

The recorder 202 can operate simultaneously with the application that is creating the animated tutorial, so that the textual description that is created is immediately available for use with, and can be automatically included within the animated tutorial. Alternatively, the recorder 202 can operate on previously created animated tutorials to add textual description to such tutorials or to create a help guide that can accompany such animated tutorials.

Further, the system includes the previously described database 264 or other similar storage system that comprises the natural language terms and phrases, and a database file or area identifying relationships between the natural language terms and phrases and the user interactions, and feedback provided to the user from the software application operating on the computerized device 200. The database 264 or similar storage application can reside within the storage device 206 or in a separate storage.

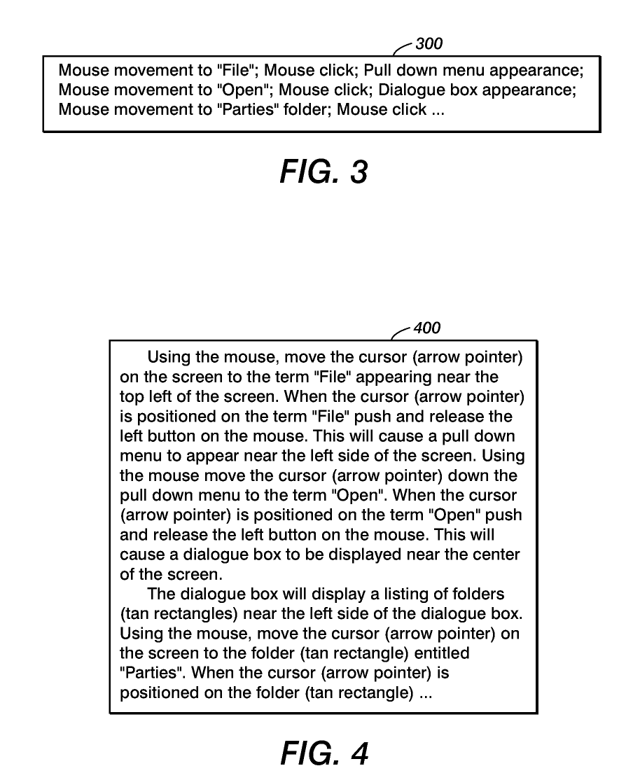

The word processor module 262 automatically adds the natural language term and/or the natural language phrase to a text file for each of the user interactions in the order in which the user performs the user interactions. FIG. 3 illustrates such a text file 300. At each user input (mouse movement, mouse click, key entry, etc.) the recorder 202 adds an entry into the text file 300 without requiring any input from the user. For example, such entries are shown as “mouse movement to ‘File’”; “Mouse click”; etc. in the text file 300. Similarly, at each point of feedback to the user from the software application being operated by the user, the recorder 202 similarly adds an entry into the text file 300 without requiring any input from the user. For example, such entries are shown as “pull down menu appearance”; “dialog box appearance”; etc., in the text file 300. This produces a string (a run on sentence) of terms and phrases in the text file 300 that can be automatically edited by the word processor module 262 to create grammatically correct phrases, sentences, and paragraphs that are used in the textual guide.

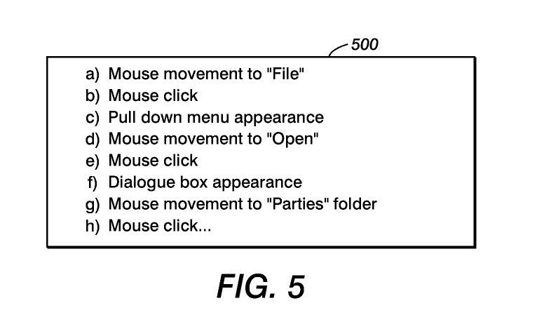

Thus, the word processor module can automatically edit the run on sentence in the text file 300 to create grammatically correct phrases, sentences, and paragraphs so as to form the textual guide 400, as shown in FIG. 4. Alternatively, the natural language terms and phrases can be listed in sentence fragments as steps that can be listed in a numerical list, in a bullet list, alphabetical list, etc. as shown in the textual guide 500 in FIG. 5.

Referring again to FIG. 4, each time the text file 300 indicates a mouse movement, the word processor module 262 can format the text to begin a sentence using the terminology “Using the mouse, move the cursor (arrow pointer) on the screen to the . . . ”. Similarly, a word processor module 262 inserts phrases that begin with “appearing near the” and other similar terminology to describe the location of various items on the screen. Also, the word processor module 262 adds language such as “push and release the left button on the mouse” to more thoroughly describe the mouse click action being taken in the animated tutorial. Therefore, the embodiments herein automatically convert the run-on sentence within the text file 300 into the grammatically proper individual sentences and paragraphs of the textual guide 400 without requiring any input from the user.

The lists, sentences, paragraphs, chapters, etc. within the textual guide 400 can be automatically divided according to pre-defined logic rules (topical, grammatical, etc.) or can be divided according to user action. Thus, for example, a new list, paragraph, or chapter could be begun each time the user took an action that made a new screen shot appear on the graphically driven program (as opposed to a change in an existing screen view).

In certain embodiments herein, a user interface can be provided that enables users to turn the automated recording and/or text generation features on or off, so that only desired operations would be recorded. The user interface can also enable users to edit and/or remove any recorded operations including the steps and settings required to perform them. The granularity of the operations is set at the discretion of the application developers who can consult with their technical and help writers to determine what type of text output would be best for the application they are developing. As described above, natural-language textual output describing the steps required to perform the recorded operations are automatically generated and written to file with embodiments herein. This text can be copied directly from the file into the training, tutorial, and/or help files.

Many computerized devices are discussed above. Computerized devices that include chip-based central processing units (CPU's), input/output devices (including graphic user interfaces (GUI), memories, comparators, processors, etc. are well-known and readily available devices produced by manufactures such as International Business Machines Corporation, Armonk N.Y., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein.

All foregoing embodiments are specifically applicable to electrostatographic and/or xerographic machines and/or processes as well as to software programs stored on the electronic memory (computer usable data carrier 206) and to services whereby the foregoing methods are provided to others for a service fee. It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof.

What is claimed is:

1. A method comprising:
recording user interactions with a computerized device;
automatically identifying matching natural language terms and phrases corresponding to said user interactions;
automatically combining said matching natural language terms and phrases into a textual guide; and
outputting said textual guide.

2. The method according to claim 1, all the limitations of which are incorporated herein by reference, wherein said recording of said user interactions comprises automatically recording:
a pattern of user inputs through a graphic user interface of a computerized device; and
an operation of a graphically driven program operating on said computerized device that result from said pattern of user inputs.

3. The method according to claim 1, all the limitations of which are incorporated herein by reference, further comprising creating a database by supplying said natural language terms and phrases to said database and providing relationships between said natural language terms and phrases and said user interactions.

4. The method according to claim 1, all the limitations of which are incorporated herein by reference, wherein said combining of said matching natural language terms and phrases comprises:
automatically adding at least one of a natural language term and natural language phrase to a text file for each of said user interactions in an order in which said user performs said user interactions; and
automatically editing said text file to create grammatically correct phrases, sentences, and paragraphs to create said textual guide.

5. The method according to claim 1, all the limitations of which are incorporated herein by reference, wherein said textual guide comprises a grammatically proper written description of said user interactions with said computerized device.

6. A method comprising:
recording user interactions with a computerized device to create an animated tutorial;
automatically identifying matching natural language terms and phrases corresponding to said user interactions that appear in said animated tutorial;
automatically combining said matching natural language terms and phrases into a textual guide; and
outputting said textual guide to accompany said animated tutorial.

7. The method according to claim 6, all the limitations of which are incorporated herein by reference, wherein said recording of said user interactions comprises automatically recording:
a pattern of user inputs through a graphic user interface of a computerized device; and
an operation of a graphically driven program operating on said computerized device that result from said pattern of user inputs.

8. The method according to claim 6, all the limitations of which are incorporated herein by reference, further comprising creating a database by supplying said natural language terms and phrases to said database and providing relationships between said natural language terms and phrases and said user interactions.

9. The method according to claim 6, all the limitations of which are incorporated herein by reference, wherein said combining of said matching natural language terms and phrases comprises:
automatically adding at least one of a natural language term and natural language phrase to a text file for each of said user interactions in an order in which said user performs said user interactions; and
automatically editing said text file to create grammatically correct phrases, sentences, and paragraphs to create said textual guide.

10. The method according to claim 6, all the limitations of which are incorporated herein by reference, wherein said textual guide comprises a grammatically proper written description of said user interactions with said computerized device.

11. A system comprising:
a computerized device comprising a memory and a graphic user interface;
a recorder operatively connected to said computerized device that records user interactions with said computerized device;
a comparator operatively connected to said recorder that automatically identifies matching natural language terms and phrases corresponding to said user interactions;
a word processor module operatively connected to said comparator automatically combining said matching natural language terms and phrases into a textual guide; and
an interface operatively connected to said word processor module that outputs said textual guide.

12. The system according to claim 11, all the limitations of which are incorporated herein by reference, wherein said recorder automatically records:
a pattern of user inputs through said graphic user interface of said computerized device; and
an operation of a graphically driven program operating on said computerized device that result from said pattern of user inputs.

13. The system according to claim 11, all the limitations of which are incorporated herein by reference, further comprising a database comprising said natural language terms and phrases, and a database file identifying relationships between said natural language terms and phrases and said user interactions.

14. The system according to claim 11, all the limitations of which are incorporated herein by reference, wherein said word processor module:
automatically adds at least one of a natural language term and natural language phrase to a text file for each of said user interactions in an order in which said user performs said user interactions; and
automatically edits said text file to create grammatically correct phrases, sentences, and paragraphs to create said textual guide.

15. The system according to claim 11, all the limitations of which are incorporated herein by reference, wherein said textual guide comprises a grammatically proper written description of said user interactions with said computerized device.

16. A computer program product comprising:
a computer-usable data carrier storing instructions that, when executed by a computer, cause the computer to perform a method comprising:
recording user interactions with a computerized device;
automatically identifying matching natural language terms and phrases corresponding to said user interactions;
automatically combining said matching natural language terms and phrases into a textual guide; and
outputting said textual guide.

17. The computer program product according to claim 16, all the limitations of which are incorporated herein by reference, wherein said recording of said user interactions comprises automatically recording:
a pattern of user inputs through a graphic user interface of a computerized device; and
an operation of a graphically driven program operating on said computerized device that result from said pattern of user inputs.

18. The computer program product according to claim 16, all the limitations of which are incorporated herein by reference, further comprising creating a database by supplying said natural language terms and phrases to said database and providing relationships between said natural language terms and phrases and said user interactions.

19. The computer program product according to claim 16, all the limitations of which are incorporated herein by reference, wherein said combining of said matching natural language terms and phrases comprises:
automatically adding at least one of a natural language term and natural language phrase to a text file for each of said user interactions in an order in which said user performs said user interactions; and
automatically editing said text file to create grammatically correct phrases, sentences, and paragraphs to create said textual guide.

20. The computer program product according to claim 16, all the limitations of which are incorporated herein by reference, wherein said textual guide comprises a grammatically proper written description of said user interactions with said computerized device.
